(19) United States
(12) Patent Application Publication
(10) Pub. No.: US 2026/0078871 A1
(43) Pub. Date: Mar. 19, 2026

(54) LUBRICATION HEALTH MONITORING SYSTEM

(71) Applicant: GM Global Technology Operations LLC, Detroit, MI (US)

(72) Inventors: Azeem Sarwar, Rochester Hills, MI (US); James A. Goodall, Hancock, MI (US); Bryan K. Pryor, Clarkston, MI (US)

(73) Assignee: GM Global Technology Operations LLC, Detroit, MI (US)

(21) Appl. No.: 18/888,729

(22) Filed: Sep. 18, 2024

(51) Int. Cl. F16N 29/04; G07C 5/00

(52) U.S. Cl. CPC F16N 29/04; G07C 5/006; F16N 2210/04; F16N 2250/04

(57) ABSTRACT

A computer-implemented method when executed by data processing hardware causes the data processing hardware to perform operations. The operations include collecting, via a health monitoring application, lubrication data at a crank phase of an engine of a vehicle, determining, at the crank phase, a pressure rise difference in oil pressure between a measured pressure and an estimated pressure, determining, via the health monitoring application, whether the measured pressure deviates from the estimated pressure at the crank phase, and generating, based on the measured pressure deviating from the estimated pressure at the crank phase, an alert.

### INTRODUCTION

The information provided in this section is for the purpose of generally presenting the context of the disclosure. Work of the presently named inventors, to the extent it is described in this section, as well as aspects of the description that may not otherwise qualify as prior art at the time of filing, are neither expressly nor impliedly admitted as prior art against the present disclosure.

The present disclosure relates generally to a lubrication health monitoring system for a vehicle.

Oil pressure in vehicles is monitored and maintained in an engine gallery during operation. Failure to maintain required pressures can lead to metal-on-metal contact, which may cause rapid engine degradation. To avoid mismanaging oil pressures, oil systems of a vehicle may detect faults in a lubrication system. The detection of lubrication system degradation is typically monitored throughout operation of the engine and lubrication system. While current systems are capable of identifying a fault, there is a need for improved fault detection in order to improve mitigation of the impact of the fault on engine safety, emissions, and overall warranty costs.

### SUMMARY

In some aspects, a computer-implemented method when executed by data processing hardware causes the data processing hardware to perform operations. The operations include collecting, via a health monitoring application, lubrication data at a crank phase of an engine of a vehicle, determining, at the crank phase, a pressure rise difference in oil pressure between a measured pressure and an estimated pressure, determining, via the health monitoring application, whether the measured pressure deviates from the estimated pressure at the crank phase, and generating, based on the measured pressure deviating from the estimated pressure at the crank phase, an alert.

In some examples, determining the pressure rise difference may include determining an oil change status of the engine. The oil change status may include a changed status and an unchanged status. The operation of determining the oil change status may include determining the oil change status is the unchanged status, detecting, based on the measured pressure deviating from the estimated pressure, an oil degradation status, and determining, based on the oil degradation status, that a pump efficiency is below an efficiency threshold. In other examples, the operation of determining the oil change status may include determining the oil change status is the changed status and detecting a first rate of change of the oil pressure and a second rate of change of the oil pressure. Optionally, the operation of detecting the first rate of change and the second rate of change may include determining the second rate of change is greater than the first rate of change and detecting, based on the second rate of change being greater than the first rate of change, a high clearance at a lubrication gallery of a lubrication system. In some instances, generating the alert may include issuing a threshold warning, the threshold warning including the second rate of change exceeding a change rate threshold. In other instances, the operation of detecting the first rate of change and the second rate of change may include determining the second rate of change is equal to or less than the first rate of change and detecting, based on the second rate of change being equal to or less than the first rate of change, an obstruction in an engine gallery of the engine.

In other aspects, a computer-implemented method when executed by data processing hardware causes the data processing hardware to perform operations. The operations include collecting, via a health monitoring application, lubrication data at a shutdown phase of an engine of a vehicle, determining, at the shutdown phase, a rate of change in oil pressure at the engine, executing, at the health monitoring application, a normalization function configured to normalize the rate of change against an oil temperature of the lubrication data, determining, via the health monitoring application, whether the rate of change deviates from a nominal change, and generating, based on the rate of change deviating from the nominal change, an alert.

In some examples, determining the rate of change may include determining an oil change status of the engine, the oil change status including a changed status and an unchanged status. The operation of determining the oil change status may include determining the oil change status is the unchanged status, detecting, via the health monitoring application, the rate of change exceeding a change rate threshold, determining, based on the rate of change exceeding the change rate threshold, an oil degradation status, and generating, based on the oil degradation status, the alert including issuing an oil change recommendation. The oil change recommendation may include a percentage of oil life. Optionally, determining the oil change status may include determining the oil change status is the changed status and detecting a first rate of change of the oil pressure and a second rate of change of the oil pressure. In some instances, the operation of detecting the first rate of change and the second rate of change may include determining the second rate of change is greater than the first rate of change and detecting, based on the second rate of change being greater than the first rate of change, a high clearance at a lubrication gallery of the engine. In some examples, generating the alert may include issuing a threshold warning, the threshold warning including the second rate of change exceeding a change rate threshold. In other instances, the operation of detecting the first rate of change and the second rate of change may include determining the second rate of change is equal to or less than the first rate of change and detecting, based on the second rate of change being equal to or less than the first rate of change, an obstruction in an engine gallery of the engine.

In further aspects, a lubrication health monitoring system for a vehicle includes data processing hardware and memory hardware in communication with the data processing hardware. The memory hardware stores instructions that when executed on the data processing hardware cause the data processing hardware to perform operations. The operations include executing, at a crank phase of an engine of the vehicle, a first lubrication system health check. The first lubrication system health check includes collecting, via a health monitoring application, lubrication data at the crank phase of an engine of a vehicle, determining, at the crank phase, a pressure rise difference in oil pressure between a measured pressure and an estimated pressure, determining, via the health monitoring application, whether the measured pressure deviates from the estimated pressure at the crank phase, and generating, based on the measured pressure deviating from the estimated pressure at the crank phase, an alert. The operations also include executing, at a shutdown phase of the engine, a second lubrication system health check. The second lubrication system health check includes collecting, via the health monitoring application, lubrication data at the shutdown phase, determining, at the shutdown phase, a rate of change in oil pressure, executing, at the health monitoring application, a normalization function, the normalization function configured to normalize the rate of change against an oil temperature of the lubrication data, determining, via the health monitoring application, whether the rate of change deviates from a nominal change, and generating, based on the rate of change deviating from the nominal change, a shutdown phase alert.

In some examples, determining the pressure rise difference may include determining an oil change status of the engine. The oil change status may include a changed status and an unchanged status. Optionally, the operation of determining the oil change status may include determining the oil change status is the unchanged status, detecting, during the first lubrication system health check, a rate of change exceeding a change rate threshold, determining, based on the rate of change exceeding the change rate threshold during the first lubrication system health check, an oil degradation status, generating, based on the oil degradation status during the first lubrication system health check, the alert including issuing an oil change recommendation, detecting, based on the measured pressure deviating from the estimated pressure during the second lubrication system health check, an oil degradation status, and determining, based on the oil degradation status during the second lubrication system health check, that a pump efficiency is below an efficiency threshold.

In other examples, the operation of determining the oil change status may include determining the oil change status is the changed status and detecting a first rate of change of the oil pressure and a second rate of change of the oil pressure. In some instances, the operation of detecting the first rate of change and the second rate of change may include determining the second rate of change is greater than the first rate of change and detecting, based on the second rate of change being greater than the first rate of change, a high clearance at a lubrication gallery of the engine. In other examples, the operation of detecting the first rate of change and the second rate of change may include determining the second rate of change is equal to or less than the first rate of change and detecting, based on the second rate of change being equal to or less than the first rate of change, an obstruction in an engine gallery of the engine.

### BRIEF DESCRIPTION OF THE DRAWINGS

The drawings described herein are for illustrative purposes only of selected configurations and are not intended to limit the scope of the present disclosure.

FIG. 1 is a schematic of a vehicle equipped with a lubrication health monitoring system according to the present disclosure;

FIG. 2 is an example block diagram of a lubrication health monitoring system according to the present disclosure;

FIG. 3 is a schematic diagram of a lubrication health monitoring system according to the present disclosure;

FIG. 4 is an exemplary flow diagram of a lubrication health monitoring system according to the present disclosure;

FIG. 5 is another exemplary flow diagram of a lubrication health monitoring system according to the present disclosure; and

FIG. 6 is yet another exemplary flow diagram of a lubrication health monitoring system according to the present disclosure.

Corresponding reference numerals indicate corresponding parts throughout the drawings.

### DETAILED DESCRIPTION

Example configurations will now be described more fully with reference to the accompanying drawings. Example configurations are provided so that this disclosure will be thorough, and will fully convey the scope of the disclosure to those of ordinary skill in the art. Specific details are set forth such as examples of specific components, devices, and methods, to provide a thorough understanding of configurations of the present disclosure. It will be apparent to those of ordinary skill in the art that specific details need not be employed, that example configurations may be embodied in many different forms, and that the specific details and the example configurations should not be construed to limit the scope of the disclosure.

The terminology used herein is for the purpose of describing particular exemplary configurations only and is not intended to be limiting. As used herein, the singular articles “a,” “an,” and “the” may be intended to include the plural forms as well, unless the context clearly indicates otherwise. The terms “comprises,” “comprising,” “including,” and “having,” are inclusive and therefore specify the presence of features, steps, operations, elements, and/or components, but do not preclude the presence or addition of one or more other features, steps, operations, elements, components, and/or groups thereof. The method steps, processes, and operations described herein are not to be construed as necessarily requiring their performance in the particular order discussed or illustrated, unless specifically identified as an order of performance. Additional or alternative steps may be employed.

When an element or layer is referred to as being “on,” “engaged to,” “connected to,” “attached to,” or “coupled to” another element or layer, it may be directly on, engaged, connected, attached, or coupled to the other element or layer, or intervening elements or layers may be present. In contrast, when an element is referred to as being “directly on,” “directly engaged to,” “directly connected to,” “directly attached to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

The terms “first,” “second,” “third,” etc. may be used herein to describe various elements, components, regions, layers and/or sections. These elements, components, regions, layers and/or sections should not be limited by these terms. These terms may be only used to distinguish one element, component, region, layer or section from another region, layer or section. Terms such as “first,” “second,” and other numerical terms do not imply a sequence or order unless clearly indicated by the context. Thus, a first element, component, region, layer or section discussed below could be termed a second element, component, region, layer or section without departing from the teachings of the example configurations.

In this application, including the definitions below, the term “module” may be replaced with the term “circuit.” The term “module” may refer to, be part of, or include an Application Specific Integrated Circuit (ASIC); a digital, analog, or mixed analog/digital discrete circuit; a digital, analog, or mixed analog/digital integrated circuit; a combinational logic circuit; a field programmable gate array (FPGA); a processor (shared, dedicated, or group) that executes code; memory (shared, dedicated, or group) that stores code executed by a processor; other suitable hardware components that provide the described functionality; or a combination of some or all of the above, such as in a system-on-chip.

The term “code,” as used above, may include software, firmware, and/or microcode, and may refer to programs, routines, functions, classes, and/or objects. The term “shared processor” encompasses a single processor that executes some or all code from multiple modules. The term “group processor” encompasses a processor that, in combination with additional processors, executes some or all code from one or more modules. The term “shared memory” encompasses a single memory that stores some or all code from multiple modules. The term “group memory” encompasses a memory that, in combination with additional memories, stores some or all code from one or more modules. The term “memory” may be a subset of the term “computer-readable medium.” The term “computer-readable medium” does not encompass transitory electrical and electromagnetic signals propagating through a medium, and may therefore be considered tangible and non-transitory memory. Non-limiting examples of a non-transitory memory include a tangible computer readable medium including a nonvolatile memory, magnetic storage, and optical storage.

The apparatuses and methods described in this application may be partially or fully implemented by one or more computer programs executed by one or more processors. The computer programs include processor-executable instructions that are stored on at least one non-transitory tangible computer readable medium. The computer programs may also include and/or rely on stored data.

A software application (i.e., a software resource) may refer to computer software that causes a computing device to perform a task. In some examples, a software application may be referred to as an “application,” an “app,” or a “program.” Example applications include, but are not limited to, system diagnostic applications, system management applications, system maintenance applications, word processing applications, spreadsheet applications, messaging applications, media streaming applications, social networking applications, and gaming applications.

The non-transitory memory may be physical devices used to store programs (e.g., sequences of instructions) or data (e.g., program state information) on a temporary or permanent basis for use by a computing device. The non-transitory memory may be volatile and/or non-volatile addressable semiconductor memory. Examples of non-volatile memory include, but are not limited to, flash memory and read-only memory (ROM)/programmable read-only memory (PROM)/erasable programmable read-only memory (EPROM)/electronically erasable programmable read-only memory (EEPROM) (e.g., typically used for firmware, such as boot programs). Examples of volatile memory include, but are not limited to, random access memory (RAM), dynamic random access memory (DRAM), static random access memory (SRAM), phase change memory (PCM) as well as disks or tapes.

These computer programs (also known as programs, software, software applications or code) include machine instructions for a programmable processor, and can be implemented in a high-level procedural and/or object-oriented programming language, and/or in assembly/machine language. As used herein, the terms “machine-readable medium” and “computer-readable medium” refer to any computer program product, non-transitory computer readable medium, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

Various implementations of the systems and techniques described herein can be realized in digital electronic and/or optical circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

The processes and logic flows described in this specification can be performed by one or more programmable processors, also referred to as data processing hardware, executing one or more computer programs to perform functions by operating on input data and generating output. The processes and logic flows can also be performed by special purpose logic circuitry, e.g., an FPGA (field programmable gate array) or an ASIC (application specific integrated circuit). Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Computer readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

To provide for interaction with a user, one or more aspects of the disclosure can be implemented on a computer having a display device, e.g., a CRT (cathode ray tube), LCD (liquid crystal display) monitor, or touch screen for displaying information to the user and optionally a keyboard and a pointing device, e.g., a mouse or a trackball, by which the user can provide input to the computer. Other kinds of devices can be used to provide interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

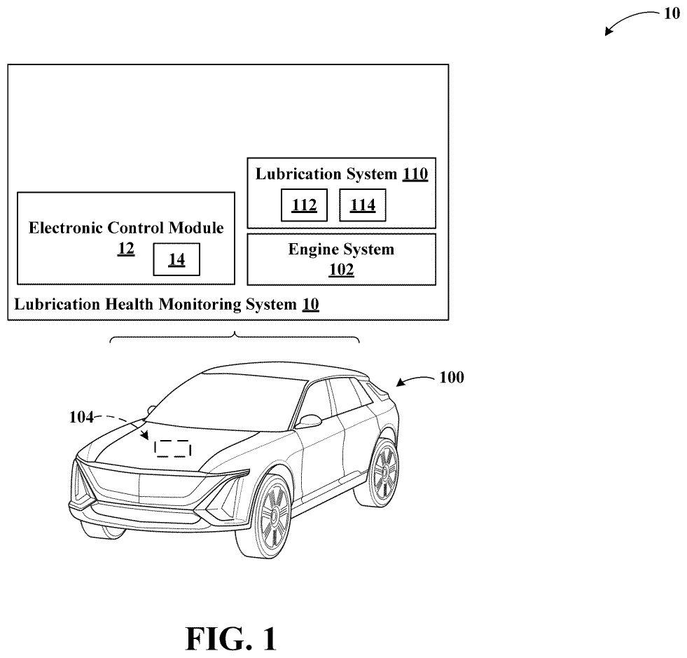

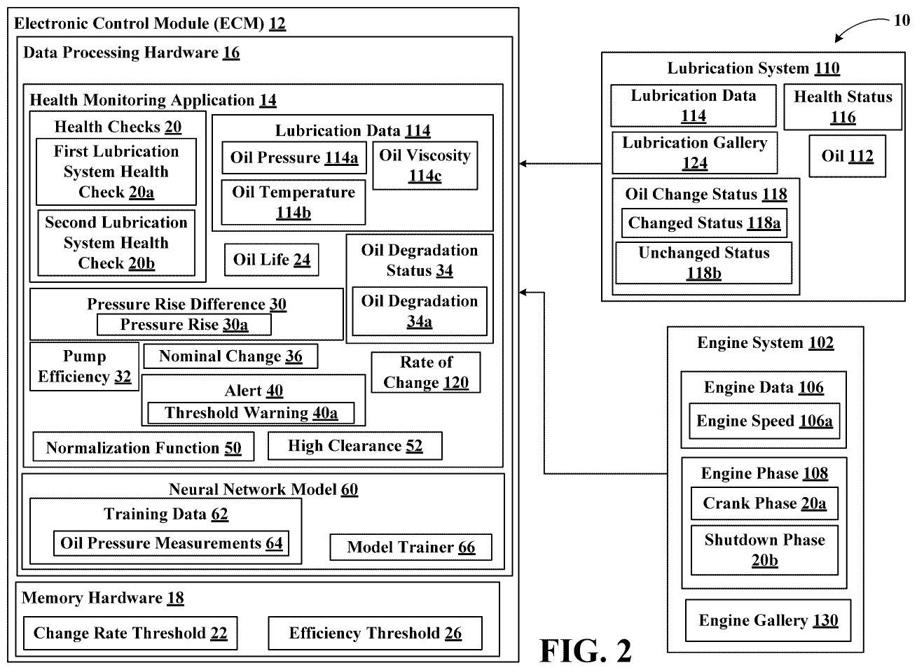

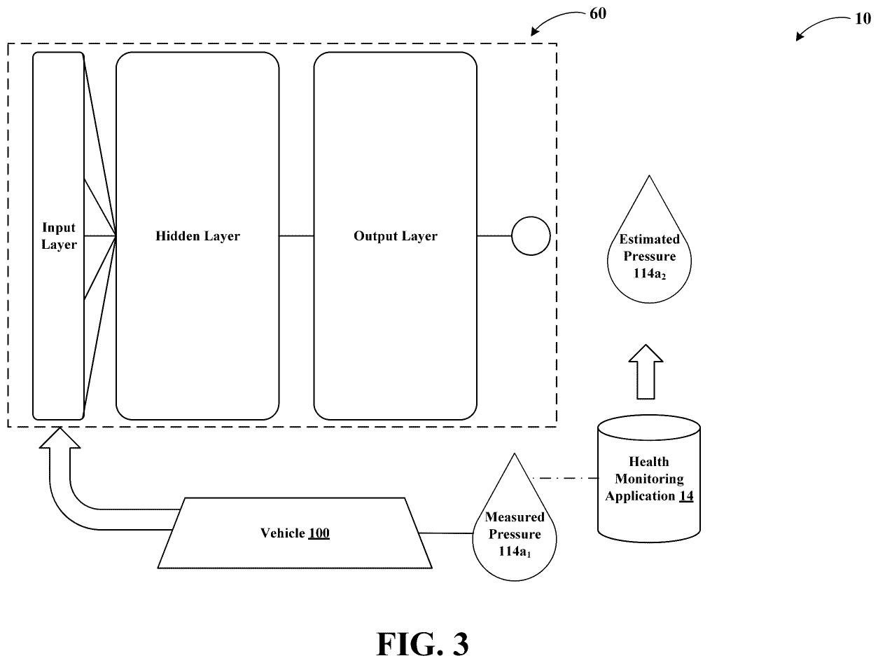

Referring to FIGS. 1-3, a lubrication health monitoring system 10 for a vehicle 100 includes an electronic control module (ECM) 12 configured with a health monitoring application 14, described herein. The health monitoring application 14 is configured to monitor a lubrication system 110 of the vehicle 100. The lubrication system 110 is configured to interface with an engine system 102 of the vehicle 100 by providing oil 112 to an engine 104 of the engine system 102. The health monitoring application 14 is configured to monitor lubrication data 114 of the lubrication system 110 during various engine phases 104.

The lubrication data 114 is captured throughout the engine system 102. The lubrication data 114 may include, but is not limited to, an oil pressure 114a, oil temperature 114b, and an oil viscosity 114c. The engine system 102 also includes engine data 106. For example, the engine data 106 may include an engine speed 106a. The engine system 102 is operable in various engine phases 108, such as a crank phase 108a and a shutdown phase 108b. The crank phase 108a generally corresponds to an operational state of the engine 104, and the shutdown phase 108b generally corresponds to an inactive state of the engine 104. The lubrication health monitoring system 10 may execute the health monitoring application 14 at either the crank phase 108a or the shutdown phase 108b to determine a health status 116 of the lubrication system 110.

With further reference to FIGS. 1-3, the ECM 12 includes data processing hardware 16 and memory hardware 18. The data processing hardware 16 is configured to execute the health monitoring application 14, and the memory hardware 18 is communicatively coupled with the data processing hardware 16. The memory hardware 18 stores instructions that, when executed on the data processing hardware 16, cause the data processing hardware 16 to perform operations, described herein. The health monitoring application 14 includes lubrication system health checks 20 that are configured to evaluate and determine the health status 116 of the lubrication system 110. The lubrication system health checks 20 may include a first lubrication system health check 20a and a second lubrication system health check 20b. The first lubrication system health check 20a corresponds to the crank phase 108a of the engine 104, such that the first lubrication system health check 20a is executed during the crank phase 108a. The second lubrication system health check 20b corresponds to the shutdown phase 108b, such that the second lubrication system health check 20b is executed during the shutdown phase 208b.

As mentioned above, the lubrication system health checks 20 are configured to monitor and determine the health status 116 of the lubrication system 110. For example, the lubrication system health checks 20 may assess an oil change status 118 of the lubrication system 110 by assessing a rate of change 120 of the oil 112, described in more detail below. The oil change status 118 may include a changed status 118a and an unchanged status 118b. For example, the changed status 118a may reflect that the oil 112 has been changed within a predetermined period of time. The unchanged status 118b reflects that the last change of the oil 112 was outside of the predetermined period of time. The oil change status 118 may be directly or indirectly related to the rate of change 120, such that determination of the rate of change 120 by the health monitoring application 14 may include determination of the oil change status 118.

The rate of change 120 may include a first rate of change 120a and a second rate of change 120b. The rate of change 120 may be utilized by the health monitoring application 14 to determine the oil life 24 of the oil 112 by identifying the rate of change 120 of measured oil pressure 114a1 during the shutdown phase 208b (i.e., after the engine 104 is shut down), described in more detail below. For example, the first rate of change 120a may be compared with the second rate of change 120b, described in more detail below. The memory hardware 18 of the ECM 12 may store a change rate threshold 22, which may be utilized in determining an oil life 24. The memory hardware 18 may also store an efficiency threshold 26 that is utilized by the health monitoring application 14 during the first lubrication system health check 20a.

Referring still to FIGS. 1-3, the first lubrication system health check 20a is executed during the crank phase 108a of the engine 104, with the health monitoring application 14 collecting the lubrication data 114 from the lubrication system 110 and the engine data 106 from the engine system 102. The health monitoring application 14 calculates or otherwise determines a pressure rise difference 30 between the measured pressure 114a1 and an estimated pressure 114a2. During the crank phase 108a, the oil pressure 114a rises from zero and overshoots a step force input driven by the movement of the engine 106. The amount of pressure rise 30a reveals a pump efficiency 32 of an oil pump, which is compared by the health monitoring application 14 against the efficiency threshold 26 stored in the memory hardware 18.

The pressure rise difference 30 of the oil pressure 114a is determined by comparing the measured pressure 114a1 and the estimated pressure 114a2. If the measured pressure 114al deviates from the estimated pressure 114a2, then the health monitoring application 14 assesses the oil change status 118. If there is no deviation from the estimated pressure 114a2, then the health monitoring application 14 continues to collect the lubrication data 114. While one example is directed to the assessment of the oil pressure 114a, the health monitoring application 14 collects a variety of lubrication data 114 as well as engine data 106 including, but not limited to, the oil temperature 114b, the engine speed 106a, and a duty cycle of the oil pump.

In addition to determining the pressure rise difference 30, the health monitoring application 14 determines an oil degradation status 34. The oil degradation status 34 is indicative of an issue with the lubrication system 110. For example, the measured pressure 114a1 deviating from the estimated pressure 114a2 may be indicative of the oil degradation status 34. For example, if the oil change status 118 is an unchanged status 118b and the measured pressure 114a1 deviates from the estimated pressure 114a2, then the health monitoring application 14 may determine that the pump efficiency 32 is below the efficiency threshold 26. As a result, the health monitoring application 14 may generate an alert 40 indicating that there is suspected degradation of the lubrication system 110.

The second lubrication health check 20b is executed during the shutdown phase 108b. The health monitoring application 14 collects, as mentioned above, the lubrication data 114 at the shutdown phase 118b of the engine 104 and determines the rate of change 120 in the oil pressure 114a at the engine 104. The health monitoring application 14 may execute a normalization function 50 that is configured to normalize the rate of change 120 against the oil temperature 114b from the lubrication data 114. For example, the oil pressure 114a, represented by the rate of change 120, may be normalized against the oil temperature 114b based on standard viscosity-temperature characteristics. The oil viscosity 114c may be lower at a high oil temperature 114b as compared to a higher oil viscosity 114c at a lower temperature 114b. The health monitoring application 14 may detect the oil degradation status 34 by deviation in the rate of change 120 after the shutdown phase 108b of the engine 106.

If there is no deviation of the rate of change 120 after the shutdown phase 108b, then the health monitoring application 14 may continue to collect and monitor the lubrication data 114 during the shutdown phase 108b. If there is deviation of the rate of change 120, then the health monitoring application 14 assesses the oil change status 118, mentioned above. The health monitoring application 14 generates an alert 40 regardless of the oil change status 118, but the detected result is dependent, at least in part, upon the oil change status 118. For example, if the oil change status 118 is the unchanged status 118a, then the health monitoring application 14 detects the oil degradation status 34 and may advise obtaining an oil change. The determination of the oil degradation status 34 and alert 40 recommending an oil change is a result of the pressure rise difference 30 exceeding the change of rate threshold 22. For example, the alert 40 may include an oil change recommendation, which may include a percentage of oil life. The percentage oil life may be determined based on how close an estimated viscosity is to the new oil. A scale is generated based on viscosity of new oil and viscosity of the highest quality of unaccepted oil. The scale is then divided into 100 equal parts. The oil life is 100 percent when the oil life is new. As the viscosity degrades and moves towards the unaccepted quality, a portion is taken away from the viscosity depending where the viscosity falls on the scale. Moreover, based on a historic driving pattern, and how the oil is degrading, an estimated time future date may be specified when the oil change could be due with an indication that the alert 40 (i.e., the recommended oil change) is based on the past observed behavior.

In another example, the oil change status 118 may be the changed status 118a. In this example, the health monitoring application 14 proceeds with assessing whether there is an increase in the oil pressure 114a. For example, the rate of change 120 may include a first rate of change 120a and a second rate of change 120b that may be detected by the health monitoring application 14. The health monitoring application 14 may determine that the second rate of change 120b is greater than the first rate of change 120a. As a result, the health monitoring application 14 detects a high clearance 52 at a lubrication gallery 124 of the lubrication system 110. The high clearance 52 detection may result in the health monitoring application 14 generating the alert 40 including issuing a threshold warning 40a. The threshold warning 40a includes that the second rate of change 120b exceeds the change rate threshold 22.

In other instances, the second rate of change 120b may be equal to or less than the first rate of change 120a. While the health monitoring application 14 may detect normal clearance for the lubrication gallery 124, the lack of an increase of the second rate of change 120b compared with the first rate of change 120a may indicate that there is an obstruction at an engine gallery 130 of the engine system 102. Thus, the health monitoring application 14 is configured to isolate faults at the lubrication gallery 124 from oil degradation 34a at the engine 104. For example, deviation between the estimated pressure 114a2 and the measured pressure 114a1 may indicate that the lubrication system 110 may have a positive oil degradation status 34.

The health monitoring application 14 is advantageously designed to be executed during the crank phase 108a and the shutdown phase 108b. Thus, the health monitoring application 14 can assess the health of the lubrication system 110 by analyzing the transience in the oil pressure 114a during the crank phase 108a and after engine shutdown (i.e., the shutdown phase 108b). The lubrication health monitoring system 10 may also be equipped with a health monitoring model 60 that is configured to output the estimated oil pressure 114a2. The health monitoring model 60 is a neural network model that is trained on training data 62 obtained from historical oil pressure measurements 64 stored in the memory hardware 18. The health monitoring model 60 may map the training data 62 to output data to generate the neural network model 60. The fully trained neural network model 60 may be used against input data (i.e., the measured oil pressure 114a1) To generate unknown output data (e.g., the estimated oil pressure 114a2). The neural network model 60 is trained using a model trainer 66 that typically trains the model 60 in batches. That is, the model 60 is typically trained on a group of input parameters at a time. However, any other modeling technique may also be employed for the model 60 including, but not limited to, linear and non-linear regression, random forests, support vector machines, etc.

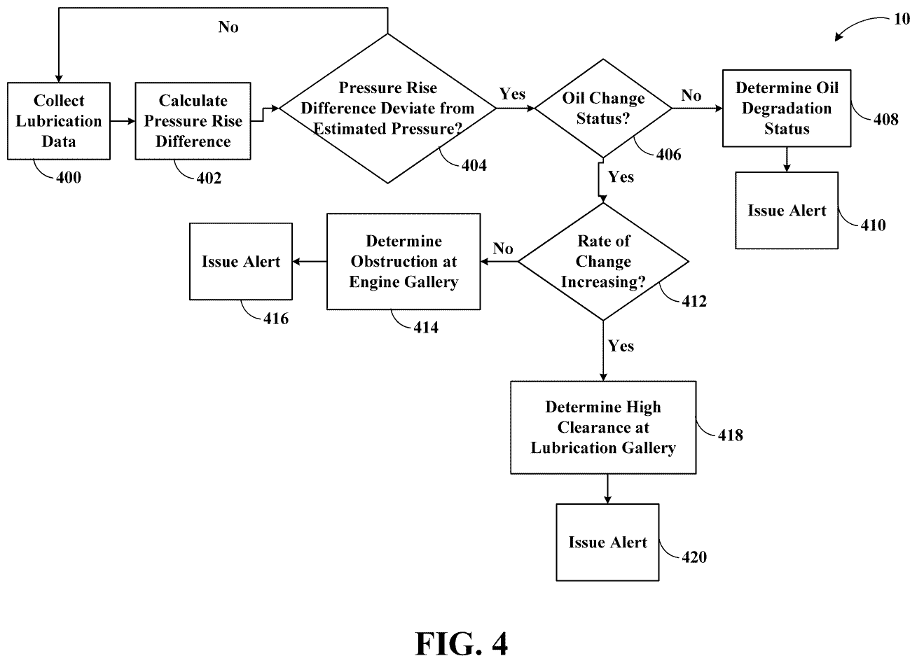

Referring now to FIG. 4, an exemplary flow diagram for the lubrication health monitoring system 10 is illustrated. At 400, the health monitoring application 14 collects the lubrication data 114 and calculates, at 402, the pressure rise difference 30 between the measured pressure 114a1 and the estimated pressure 114a2. The health monitoring application 14 determines, at 404, whether the pressure rise difference 30 deviates from the estimated pressure 114a2. If the pressure rise difference 30 does not deviate from the estimated pressure 114a2, then the health monitoring application 14 continues to collect the lubrication data 114. If the pressure rise difference 30 deviates from the estimated pressure 114a2, then the health monitoring application 14 determines, at 406, an oil change status 118. If the oil change status 118 is an unchanged status 118b, then the health monitoring application 14 determines, at 408, the oil degradation status 34 and issues, at 410, an alert 40 corresponding to the pump efficiency 32 decreasing below the efficiency threshold 22.

If the oil change status 118 is a changed status 118a, then the health monitoring application 14 determines, at 412, whether the rate of change 120 is increasing. If the rate of change is not increasing, then the health monitoring application 14 determines, at 414, that the engine gallery 126 has an obstruction and issues, at 416, an alert 40 indicating the rate of change 120 exceeds the threshold 22. If the rate of change 120 is increasing, the health monitoring application 14 determines, at 418, that the lubrication gallery 124 has a high clearance 52 and the issues, at 420, an alert 40 that the rate of change 120 exceeds the change rate threshold 22.

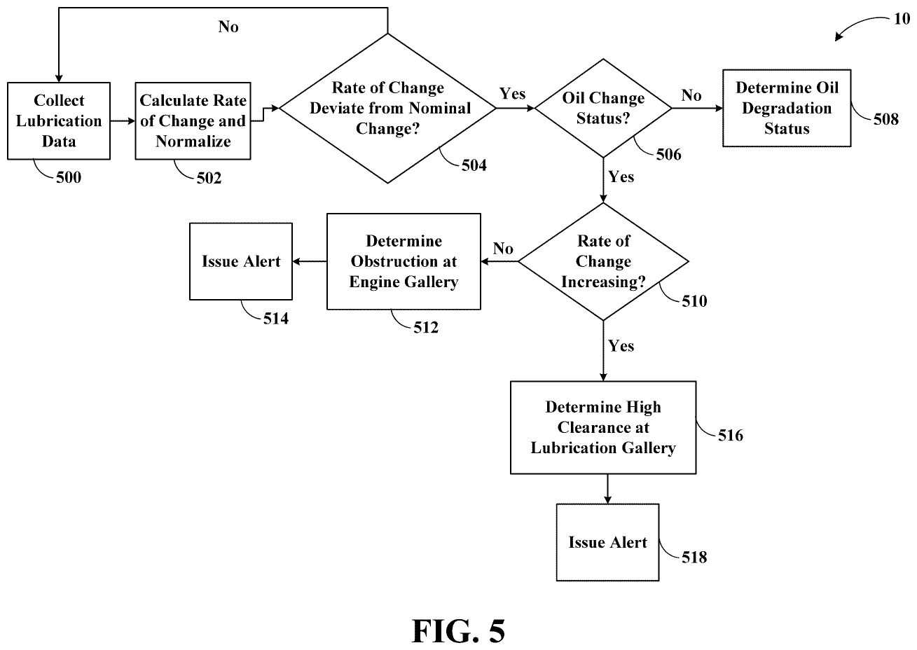

Referring now to FIG. 5, another exemplary flow diagram for the lubrication health monitoring system 10 is illustrated. At 500, the health monitoring application 14 collects the lubrication data 114 and calculates, at 502, the rate of change 120 and normalizes the rate of change 120 against the oil temperature 114b. The health monitoring application 14, at 504, determines whether the rate of change 120 deviates from the nominal change 36. If the rate of change 120 does not deviate from the nominal change 36, then the health monitoring application 14 continues to collect the lubrication data 114. If the rate of change 120 deviates from the nominal change 36, then the health monitoring application 14 determines, at 506, the oil change status 118. If the oil change status 118 is the unchanged status 118b, then the health monitoring application 14 determines an oil degradation status 34, at 508.

If the oil change status 118 is a changed status 118a, then the health monitoring application 14 determines, at 510, whether the rate of change 120 is increasing. If the rate of change is not increasing, then the health monitoring application 14 determines, at 512, that the engine gallery 126 has an obstruction and issues, at 514, an alert 40 indicating the rate of change 120 exceeds the threshold 22. If the rate of change 120 is increasing, the health monitoring application 14 determines, at 516, that the lubrication gallery 124 has a high clearance 52 and the issues, at 518, an alert 40 that the rate of change 120 exceeds the change rate threshold 22.

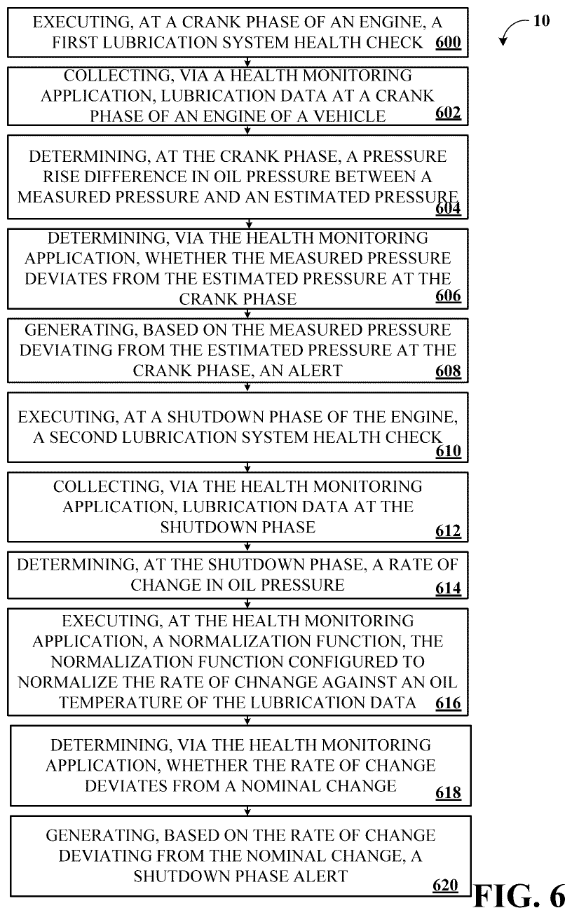

Referring now to FIG. 6, yet another exemplary flow diagram for the lubrication health monitoring system 10 is illustrated. At 600, the lubrication health monitoring system 10 executes a first lubrication system health check 20a at the crank phase 108a of the engine 104. At 602, the health monitoring application 14 collects the lubrication data 114 at the crank phase 108a of the engine 104 of the vehicle 100. The lubrication health monitoring system 10 determines, at 604, a pressure rise difference 30 in the oil pressure 114a between the measured pressure 114a1 and the estimated pressure 114a2 at the crank phase 108a. At 606, the health monitoring application 14 determines whether the measured pressure 114a1 deviates from the estimated pressure 114a2 at the crank phase 108a. Based on the measured pressure 114a1 deviating from the estimated pressure 114a2, the lubrication health monitoring system 10 generates, at 608, an alert 40.

The lubrication health monitoring system 10, at 610, executes a second lubrication system health check 20b. At 612, the health monitoring application 14 collects the lubrication data 114 at the shutdown phase 108b of the engine 104. The lubrication health monitoring system 10 determines, at 614, the rate of change 120 in the oil pressure 114a at the engine 104 during the shutdown phase 108b. The health monitoring application 14 executes, at 616, a normalization function 50 configured to normalize the rate of change 120 against an oil temperature 114b of the lubrication data 114. The health monitoring application 14 determines, at 618, whether the rate of change 120 deviates from the nominal change 36 and generates, at 620, an alert 40 based on the rate of change 120 deviating from the nominal change 36.

A number of implementations have been described. Nevertheless, it will be understood that various modifications may be made without departing from the spirit and scope of the disclosure. Accordingly, other implementations are within the scope of the following claims.

The foregoing description has been provided for purposes of illustration and description. It is not intended to be exhaustive or to limit the disclosure. Individual elements or features of a particular configuration are generally not limited to that particular configuration, but, where applicable, are interchangeable and can be used in a selected configuration, even if not specifically shown or described. The same may also be varied in many ways. Such variations are not to be regarded as a departure from the disclosure, and all such modifications are intended to be included within the scope of the disclosure.

What is claimed is:

1. A computer-implemented method when executed by data processing hardware causes the data processing hardware to perform operations comprising:
collecting, via a health monitoring application, lubrication data at a crank phase of an engine of a vehicle;
determining, at the crank phase, a pressure rise difference in oil pressure between a measured pressure and an estimated pressure;
determining, via the health monitoring application, whether the measured pressure deviates from the estimated pressure at the crank phase; and
generating, based on the measured pressure deviating from the estimated pressure at the crank phase, an alert.

2. The method of claim 1, wherein determining the pressure rise difference includes determining an oil change status of the engine, the oil change status including a changed status and an unchanged status.

3. The method of claim 2, wherein determining the oil change status includes:
determining the oil change status is the unchanged status;
detecting, based on the measured pressure deviating from the estimated pressure, an oil degradation status; and
determining, based on the oil degradation status, that a pump efficiency is below an efficiency threshold.

4. The method of claim 2, wherein determining the oil change status includes:
determining the oil change status is the changed status; and
detecting a first rate of change of the oil pressure and a second rate of change of the oil pressure.

5. The method of claim 4, wherein detecting the first rate of change and the second rate of change includes:
determining the second rate of change is greater than the first rate of change; and
detecting, based on the second rate of change being greater than the first rate of change, a high clearance at a lubrication gallery of a lubrication system.

6. The method of claim 5, wherein generating the alert includes issuing a threshold warning, the threshold warning including the second rate of change exceeding a change rate threshold.

7. The method of claim 4, wherein detecting the first rate of change and the second rate of change includes:
determining the second rate of change is equal to or less than the first rate of change; and
detecting, based on the second rate of change being equal to or less than the first rate of change, an obstruction in an engine gallery of the engine.

8. A computer-implemented method when executed by data processing hardware causes the data processing hardware to perform operations comprising:
collecting, via a health monitoring application, lubrication data at a shutdown phase of an engine of a vehicle;
determining, at the shutdown phase, a rate of change in oil pressure at the engine;
executing, at the health monitoring application, a normalization function configured to normalize the rate of change against an oil temperature of the lubrication data;
determining, via the health monitoring application, whether the rate of change deviates from a nominal change; and
generating, based on the rate of change deviating from the nominal change, an alert.

9. The method of claim 8, wherein determining the rate of change includes determining an oil change status of the engine, the oil change status including a changed status and an unchanged status.

10. The method of claim 9, wherein determining the oil change status includes:
determining the oil change status is the unchanged status;
detecting, via the health monitoring application, the rate of change exceeding a change rate threshold;
determining, based on the rate of change exceeding the change rate threshold, an oil degradation status; and
generating, based on the oil degradation status, the alert including issuing an oil change recommendation, the oil change recommendation including a percentage of oil life.

11. The method of claim 9, wherein determining the oil change status includes determining the oil change status is the changed status and detecting a first rate of change of the oil pressure and a second rate of change of the oil pressure.

12. The method of claim 11, wherein detecting the first rate of change and the second rate of change includes:
determining the second rate of change is greater than the first rate of change; and
detecting, based on the second rate of change being greater than the first rate of change, a high clearance at a lubrication gallery of the engine.

13. The method of claim 12, wherein generating the alert includes issuing a threshold warning, the threshold warning including the second rate of change exceeding a change rate threshold.

14. The method of claim 11, wherein detecting the first rate of change and the second rate of change includes:
determining the second rate of change is equal to or less than the first rate of change; and
detecting, based on the second rate of change being equal to or less than the first rate of change, an obstruction in an engine gallery of the engine.

15. A lubrication health monitoring system for a vehicle, the lubrication health monitoring system comprising:
data processing hardware; and
memory hardware in communication with the data processing hardware, the memory hardware storing instructions that when executed on the data processing hardware cause the data processing hardware to perform operations comprising:
executing, at a crank phase of an engine of the vehicle, a first lubrication system health check, the first lubrication system health check including:
collecting, via a health monitoring application, lubrication data at the crank phase of an engine of a vehicle;
determining, at the crank phase, a pressure rise difference in oil pressure between a measured pressure and an estimated pressure;
determining, via the health monitoring application, whether the measured pressure deviates from the estimated pressure at the crank phase; and
generating, based on the measured pressure deviating from the estimated pressure at the crank phase, an alert; and
executing, at a shutdown phase of the engine, a second lubrication system health check, the second lubrication system health check including:
collecting, via the health monitoring application, lubrication data at the shutdown phase;
determining, at the shutdown phase, a rate of change in oil pressure;
executing, at the health monitoring application, a normalization function, the normalization function configured to normalize the rate of change against an oil temperature of the lubrication data;
determining, via the health monitoring application, whether the rate of change deviates from a nominal change; and
generating, based on the rate of change deviating from the nominal change, a shutdown phase alert.

16. The lubrication health monitoring system of claim 15, wherein determining the pressure rise difference includes determining an oil change status of the engine, the oil change status including a changed status and an unchanged status.

17. The lubrication health monitoring system of claim 16, wherein determining the oil change status includes:
determining the oil change status is the unchanged status;
detecting, during the first lubrication system health check, a rate of change exceeding a change rate threshold;
determining, based on the rate of change exceeding the change rate threshold during the first lubrication system health check, an oil degradation status;
generating, based on the oil degradation status during the first lubrication system health check, the alert including issuing an oil change recommendation;
detecting, based on the measured pressure deviating from the estimated pressure during the second lubrication system health check, an oil degradation status; and
determining, based on the oil degradation status during the second lubrication system health check, that a pump efficiency is below an efficiency threshold.

18. The lubrication health monitoring system of claim 16, wherein determining the oil change status includes determining the oil change status is the changed status and detecting a first rate of change of the oil pressure and a second rate of change of the oil pressure.

19. The lubrication health monitoring system of claim 18, wherein detecting the first rate of change and the second rate of change includes:
determining the second rate of change is greater than the first rate of change; and
detecting, based on the second rate of change being greater than the first rate of change, a high clearance at a lubrication gallery of the engine.

20. The lubrication health monitoring system of claim 18, wherein detecting the first rate of change and the second rate of change includes:
determining the second rate of change is equal to or less than the first rate of change; and
detecting, based on the second rate of change being equal to or less than the first rate of change, an obstruction in an engine gallery of the engine.
